(19) United States
(12) Patent Application Publication
(10) Pub. No.: US 2009/0150926 A1
(43) Pub. Date: Jun. 11, 2009

(54) Method And Apparatus For Delivering SDV Programming With Targeted Advertising To Selected Groups Of Subscribers

(75) Inventor: John Schlack, Quakertown, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/951,815

(22) Filed: Dec. 6, 2007

(51) Int. Cl. H04N 7/173; H04N 7/00

(52) U.S. Cl. 725/34; 725/98

(57) ABSTRACT

A switched digital video (SDV) system includes an SDV manager for coordinating a SDV session requested by a subscriber terminal and a storage medium on which resides content to be transmitted during the SDV session. The system also includes a plurality of edge devices for receiving a transport stream that includes content provided by the storage medium and transmitting the transport stream over an access network to the subscriber terminal on one of a plurality of SDV channels. The SDV manager is configured to cause different renditions of an SDV program to be provided by the edge devices to subscriber terminals associated with different target groups. The target groups each include a plurality of subscriber terminals that is less than a number of subscriber terminals serviced by a distinct edge device or devices.

### FIELD OF THE INVENTION

The present invention relates generally to a switched digital video system for distributing content to a subscriber over a system such as a satellite or cable television system, and more particularly to a switched digital video system in which advertising can be targeted to selected groups of subscribers.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on-demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize a session manager to manage SDV sessions. The subscriber will set up an SDV session with the session manager when an SDV program is requested. The session manager will determine if the requested channel is already being sent to the corresponding service group that the subscriber belongs to. The subscriber will be assigned to join the existing SDV session if the requested channel is available at the service group or assigned to a new SDV session if the requested channel is not available at the service group. The Session Manager will negotiate with the edge devices to allocate resources required for the session. The edge device (e.g., a digital modulator such as a QAM modulator) needs to dynamically retrieve the MPEG single program transport stream that carries the requested broadcast program (likely via IP unicast or multicast) and generate the MPEG multiple program transport stream. As part of the session setup response message, the video tuning parameters such as frequency and MPEG program number are sent back to the subscriber to access the requested broadcast channel.

As with other types of broadcast programming, advertising forms an important part of SDV programming. The revenues generated from advertisers subsidize and in some cases pay entirely for the programming. Even in subscriber-based television systems such as cable and satellite television systems, the revenues from advertisements subsidize the cost of the programming, and were it not for advertisements, the monthly subscription rates of such systems could be many times higher than at present.

Traditional broadcast television systems broadcast the same television signal to each person viewing a particular station. Thus, each person viewing a particular channel will necessarily view the same programming content as well as the same advertisements embedded in the programming content. However, with modern digital television systems such as SDV systems more personalized television service is possible. For instance, in SDV systems, a group of subscriber households can be selectively addressed through a cable node serving that group. Similarly, individual subscriber households can be selectively addressed though their set top terminals. In other words, the service provider can send different data to different subscribers or groups of subscribers.

Typically, a particular advertiser will purchase a particular “spot”, i.e., an advertising opportunity in a particular channel at a particular time, based on the likelihood that members of that advertiser's target audience will be watching that particular channel at that particular time. For instance, advertisers typically have a particular demographic group of individuals that they wish to reach with their advertising. For example, the manufacturer of a low-cost beer probably has a primary target audience of males between the ages of 21 and 39, living in households with a household annual income of less than $75,000 per year. As another example, a manufacturer of laundry detergent may have a primary target audience of women between 19-59 years of age with no particular preference regarding household income. As another example, a manufacturer of expensive beer may wish to have a target audience similar to that of the manufacturer of low-cost beer in that it comprises males between the ages of 21 and 39. However, this manufacturer's target demographic audience may include a different economic profile, e.g., males between the ages of 21 and 39, living in households with annual household incomes of over $60,000 per year. Another advertiser that manufactures children's toys appropriate for children between 5 and 10 years of age might have a target audience of children between the ages of 5 and 10 and, depending upon the particular toys, a desired annual household income range.

SDV programming, and the advertisements associated therewith, may be supplied by a multicasting technique or a unicasting technique. If conventional SDV multicasting is employed, when a set top terminal in a particular service group requests an SDV program, the SDV manager directs the QAM modulator servicing that particular service group to issue an Internet Group Management Protocol (IGMP) Join request to receive the multicast stream. The QAM modulator then delivers a single copy of the channel supporting the program to that service group. The SDV manager directs the set top terminal that made the request to tune to the appropriate channel. Any other set top terminals in the same service group which request the same programming are also directed to tune to that channel. That is, when multicasting is employed, a single video stream is provided from the headend to the hub and the video stream is carried on a single channel from the hub to the appropriate service group. Accordingly, multicasting minimizes bandwidth usage between the headend and the hub as well as between the hub and service group.

In contrast to multicasting, when conventional SDV unicasting is employed each set top terminal receives its own copy of a channel. More specifically, when a set top terminal in a particular service group requests an SDV program, the SDV manager directs the headend to deliver a unicast video stream to a particular port on the QAM modulator servicing the set top terminal that made the request. In this case the SDV manager does not need to communicate with the edge resource manager in the hubs since the unicast video stream is being sent directly to a predetermined port on the appropriate QAM modulator. The QAM modulator, in turn, delivers a single copy of the channel supporting the unicast video stream to the appropriate service group. The SDV manager then directs the set top terminal that made the request to tune to that particular channel supporting the unicast video stream. This process used to unicast an SDV channel is similar to the process used in video on demand (VOD) since in both cases each set top terminal receives its own copy of the channel. A large bandwidth is needed when unicasting SDV channels. In contrast to multicasting, with unicasting there are no bandwidth savings when multiple viewers request the same SDV programming and, as a result, the bandwidth required to provide many dedicated channels at peak viewing times can be much greater than the available RF spectrum between the hub and the set top terminals.

### BRIEF DESCRIPTION OF THE DRAWINGS

FIG. 1 shows one example of a system architecture for delivering switched digital video content to a subscriber.

FIGS. 2 and 3 show examples of a headend that can be used to deliver SDV programming to target groups of subscribers.

FIG. 4 illustrates the process of groupcasting using multicast streams between a headend and a hub.

FIG. 5 shows one example of a headend that is configured to perform groupcasting using streaming servers for multicasting the groupcast streams.

FIG. 6 shows one example of a set top terminal.

FIG. 7 is flowchart showing one example of a method for providing SDV programming with advertising that is directed to target groups of subscribers.

### DETAILED DESCRIPTION

As previously mentioned, the selective addressability of modern digital television service systems renders more targeted TV advertising possible. As a result, demographic data may be used to provide different subscribers of the same television program different advertisements that are particularly directed to them. In order to effectively target advertising to subscribers it is necessary to understand certain attributes of the target subscriber, such as demographic and psychograph attributes, and to acquire any data relevant to determining the appropriateness of an ad for the particular subscriber. Such data can include past viewing habits and previous purchasing selections and the like.

The degree to which advertising can be targeted to subscribers viewing SDV programming depends in part on whether the SDV programs are multicast or unicast from the system headend or other centralized location. When multicasting is employed, advertising can be targeted to groups of set top terminals as small as a service group, which is the group of set top terminals that are serviced by a single edge device. On the other hand, when unicasting is employed, advertising can be targeted to individual set top terminals. Unicasting, however, requires a relatively large amount of bandwidth.

As detailed below, a method is provided for delivering SDV programming in which advertising is targeted to specific groups of set top terminals without the use of an excessive amount of bandwidth. More particularly, the targeted advertising can be provided at a level below that of the service group.

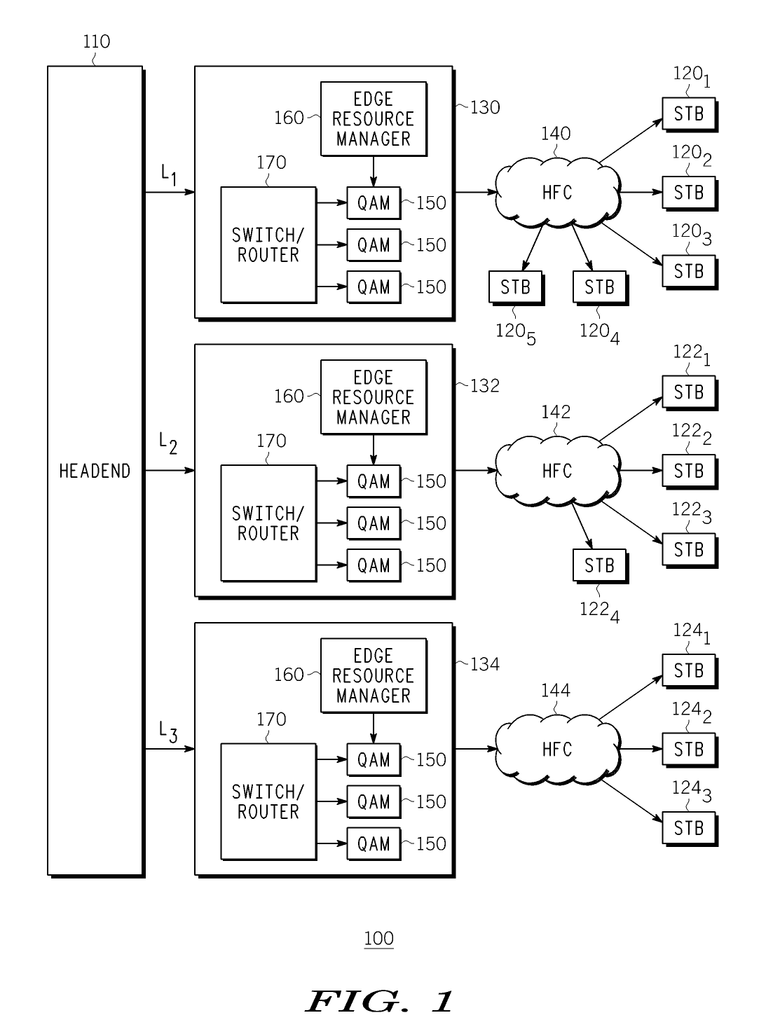

FIG. 1 is a system architecture 100 for delivering switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132 and 134 may communicate over a packet-switched network such as a cable data network, passive optical network (PON) or the like using, for example, IP multicast or unicast addressing. Details concerning multicast and unicast addressing as they pertain to targeted advertising will be presented below. As used herein, advertising refers to any content that interrupts the primary content that is of interest to the viewer. Accordingly, advertising can include but is not limited to, content supplied by a sponsor, the service provider, or any other party, which is intended to inform the viewer about a product or service. For instance, public service announcements, station identifiers and the like are also referred to as advertising.

Some or even all of the hubs are connected to multiple users, typically via distribution networks such as local cable access networks (e.g., HFC networks). For simplicity of explanation only, each hub is shown as being connected to a distinct HFC network, which in turn communicates with end user equipment as illustrated. In particular hubs 130, 132 and 134 in FIG. 1 communicate with access networks 140, 142 and 144, respectively. Each access network 140, 142 and 144 in turn communicates with multiple end user devices such as set top terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by the MSO that operates the network.

Each hub 130, 132 and 134 also includes an edge resource manager 160 for allocating and managing the resources of the edge devices 150. The edge resource manager 160 communicates with and receives instructions from the session manager located in the headend 110.

When a viewer selects an SDV channel using a subscriber terminal such as a set top terminal, the SDV system actively switches the channel onto one of the QAMs that serves that particular set top terminal. The set top terminals are generally arranged into service groups and each of the service groups is assigned to, and serviced by, one or more QAM modulators. For example, in the arrangement depicted in FIG. 1 set top terminals 120₁, 120₂, 120₃, 120₄ and 120₅ are assigned to QAM modulators 150 located at hub 130, set top terminals 122₁, 122₂, 122₃ and 122₄ are assigned to QAM modulators 150 located at hub 132, and set top terminals 124₁, 124₂ and 124₃ are assigned to QAM modulators 150 located at hub 134. Typically, four (4) or eight (8) QAM modulators are deployed per service group to carry the SDV channels. SDV service groups currently include from about 500 to 1000 set top terminals. Depending on the system topology, there may or may not be a one-to-one correspondence between the hubs and the service groups. For instance, it is typically the case that each hub serves multiple service groups.

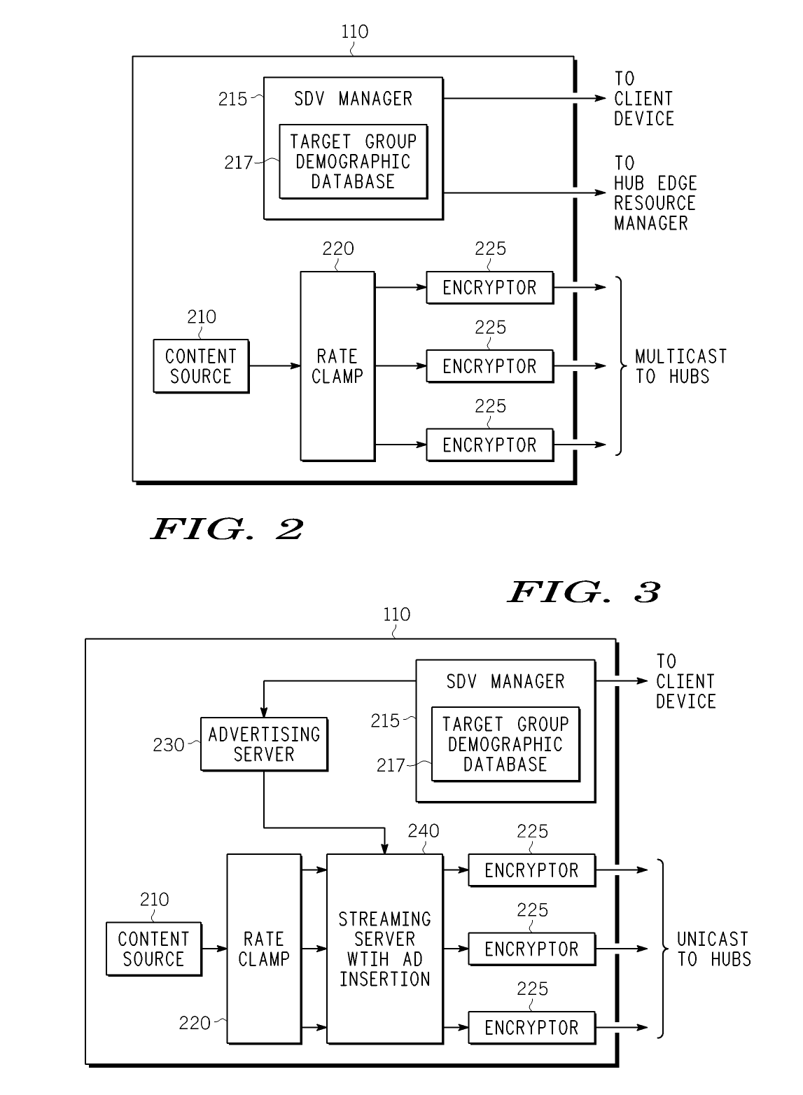

FIGS. 2 and 3 show two examples of headend 110. The example presented in FIG. 2 is often associated with a headend that multicasts programming to the hubs while the example in FIG. 3 is often associated with a headend that unicasts programming to the hubs. More generally, however, each headend can be used to distribute programming in accordance with either a multicasting or unicasting technique.

Referring to FIG. 2, the headend 110 includes a broadcast content source 210, which may include, by way of example, satellite receivers, off-air receivers and/or content storage devices such as servers. An SDV manager 215 is used to determine which SDV transport streams are active at any time and for directing the set top terminals to the appropriate stream. The SDV manager 215 also keeps track of which subscribers are watching which channels and it communicates with the edge resource managers 160 (see FIG. 1) in the hubs so that the content can be switched on and off under the control of the SDV manager 215. In addition, all subscriber requests for a switched digital channel go through the SDV manager 215. Content is forwarded by the content source to a rate clamp 220 and one or more encryptors 225. The content is then encrypted by the encryptors 225 and transmitted to the appropriate hub or hubs using, in this example, multicast addressing. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown).

It should be noted that the headend 110 shown in FIG. 2 as well as in FIG. 3, may also include a variety of other components for offering additional services. For example, the head-end 110 may comprise typical head-end components and services including a billing module, a video-on-demand (VOD) server, a subscriber management system (SMS), a conditional access system and a LAN(s) for placing the various components in data communication with one another. Also, although not shown, one of ordinary skill in the art would recognize that other components and arrangements for achieving the various functionalities of headend 110 are possible. It will also be appreciated that the head-end configurations depicted in FIGS. 2 and 3 are high-level, conceptual architectures and that each system may have multiple head-ends deployed using different architectures.

Referring now to the headend 110 depicted in FIG. 3, the headend 110 once again includes a broadcast content source 210 and an SDV manager 215. Content is forwarded by the content source to a rate clamp 220, a streaming server 240 and one or more encryptors 225. The streaming server 240 stores the content and inserts ads into the programming that are provided by ad server 230. The advertising server 230 operates under the control of the SDV manager 215. The SDV manager 215 determines the appropriate ads to be inserted at the appropriate times in the programming. The content is then encrypted by the encryptors 225 and transmitted to the appropriate hub or hubs using, in this example, unicast addressing.

In terms of advertising, multicasting SDV programming allows different renditions of a program to be sent to different service groups. Each rendition, which can include different advertising targeted to the set top terminals in those service groups, is carried on a different multicast stream between the headend and the hubs. Stated differently, multicasting of SDV programming allows targeted advertising down to the granularity of a service group. That is, each service group can receive a rendition of an SDV channel tailored to that service group. However, in practice the maximum number of different multicast streams that can be provided by a headend such as depicted in FIG. 2 is usually fixed because of hardware limitations and may be less than the number of different service groups. In other words, in practice each service group may not be able to receive a unique multicast stream.

On the other hand, unicasting SDV programming allows a different rendition of a program to be sent to each set top terminal in a service group since each terminal receives its own copy of a program. That is, unicasting of SDV programming allows targeted advertising down to the granularity of a set top terminal. The price of this fine degree of granularity is that a large amount of bandwidth is needed. Of course, in many cases this fine degree of granularity is not necessary to effectively target advertising since subscribers can be grouped by various demographic and other means. Unfortunately, the relatively coarse degree of granularity offered by SDV multicasting, which allows targeted advertising down to the level of individual service groups, is often insufficient. Ideally, a service provider would like to offer advertisers any desired degree of granularity between these two extremes.

In summary, conventional SDV multicasting and unicasting as described above do not allow set top terminals to be grouped at any level of granularity between the service group at one end and the individual set top terminal at the other end. In many cases it would be desirable to arrange different target groupings of set top terminals based on any of a variety of demographic criteria (e.g., geographic region, household income, viewer age, shopping history, channel viewing history). Different renditions of a program can then be provided to each of the different target groups. For convenience, this process of providing SDV channels by targeting groups of set top terminals with group sizes between an individual set top terminal and a service group will be referred to as SDV groupcasting.

The SDV manager or other entity can be used to implement SDV groupcasting by delivering multiple copies of an SDV channel to a service group, where each copy carries a different rendition of the programming. Set top terminals that belong to the same target group will be directed by the SDV manager to tune to the same channel when they request a particular program. The SDV manager can implement SDV groupcasting using either multicast or unicast streams.

To implement SDV groupcasting using multicast streams, multiple renditions of a program are created—one rendition for each target group. Each rendition will include different advertising based on the characteristics of the target group. To this end, as shown in FIGS. 2 and 3, the SDV manager 215 includes a target group demographic database 217 that specifies the demographics of each target group and assigns the set top terminals 120 to one (or more) of the target groups. The demographic data located in the database 217 can be acquired in any of a variety of different ways. For example, subscriber viewing history, subscriber geography and subscriber self-reporting in response to questionnaires and the like may all be used to populate the target group demographic database 217. Of course, target group demographic database 217 need not necessarily physically reside in the SDV manager 215, but rather may be discrete or combined with other components. In addition, while in FIGS. 2 and 3 the database 217 is located in the headend, the database 217 more generally may reside in any suitable location within the SDV system. For example, in some cases it may be convenient to locate the target group demographic database 217 in the hubs.

The various renditions of the program specified by the SDV manager 215 are all multicast from the headend to the hubs. When a set top terminal requests the program, the SDV manager directs the edge device servicing that set top terminal to issue an IGMP join request to receive the appropriate multicast stream for that particular set top terminal. The appropriate multicast stream is the stream that includes the rendition of the program that matches the target group to which the set top terminal belongs. For example, returning to an earlier example, one rendition of the program may include an advertisement for low-cost beer. This rendition may be directed to a target group of males between the ages of 21 and 39 living in a household with annual incomes of less than $75,000 per year who spend more than 50% of their viewing time watching sporting events. Without the use of groupcasting as described herein, this precise a level of targeted advertising would have been difficult to achieve unless unicasting were employed.

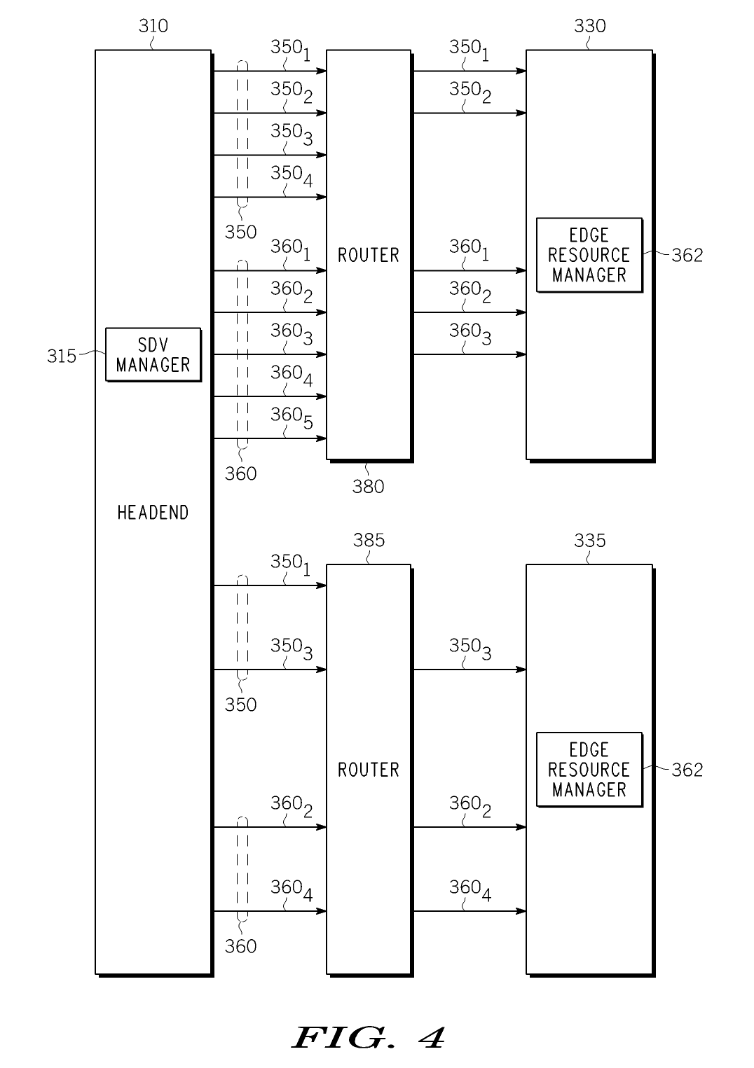

After the edge device has been directed to receive the multicast stream that includes the appropriate rendition of the programming, the edge device delivers a single copy of the channel containing the content of the multicast stream to the service group to which the set top terminal that made the request belongs. Finally, the SDV manager directs the set top terminal to tune to the channel on which the programming is available. FIG. 4 illustrates this process of groupcasting using multicast streams.

Referring to FIG. 4, two programs are multicast from the headend 310 to hubs 330 and 335 via routers 380 and 385, respectively. One program is represented by multicast streams 350 and the other program is represented by multicast streams 360. The individual multicasts streams 350₁, 350₂ and 350₃ include different renditions of the same programming. Each rendition is tailored to a different target group of set top terminals. When a set top terminal in say, service group 2 requests a program supported by multicast streams 350, the SDV manager 315 determines which target group the set top terminal belongs. The SDV manager 315 directs the edge device (via the edge resource manager 362) to issue a IGMP join request to receive the particular one of the multicast streams 350 that is intended for that target group. For example, the set top terminal serviced by hub 330 and making the request may belong to a target group associated with the rendition of the program supported on multicast stream 350₂. In this case the edge device receives the multicast stream 350₂ after issuing the IGMP request and forwards it to service group 2 on an appropriate channel. In this case router 380 is only shown forwarding multicast stream 350₂ to the hub 330. The SDV manager 315 directs the set top terminal to tune to this channel. Likewise, if another set top terminal serviced by hub 330 in service group 2 requests the same programming and it belongs to the same target group, it too will be directed to tune to this channel. On the hand, if another set top terminal in service group 2 requests the same programming, but it belongs to a different target group, the process described above will be repeated so that it receives the particular one of the multicast streams 350 appropriate for its target group. Similarly, set top terminals serviced by hub 335 requesting multicast streams 350₃, 360₂ and 360₄ are forwarded to hub 335 via router 385.

The process of SDV groupcasting using multicast streams as described above in connection with FIG. 4 allows more precisely targeted advertising than SDV multicasting since set top terminals within a service group can be grouped together into target groups that are smaller than the service groups. One drawback of this process, however, is that the number of target groups cannot be dynamically adjusted since ad insertion occurs in a centralized location. Also, changing the criteria used to define the target groups affects multiple SDV managers serving different geographic regions. Another drawback arises because the headend needs to produce many renditions of a program.

As previously mentioned, groupcasting may also be achieved using unicast streams rather than multicast streams. This process is similar to the process of SDV unicasting described above in connection with FIG. 3, except that in groupcasting the SDV manager 215 directs all members of the target group who request the same programming to tune to the same channel. Since groupcasting using unicast streams allows an essentially unlimited number of renditions of program to be provided, the number of different target groups that can be formed is also essentially unlimited. Therefore, very precise targeting of subscribers can be achieved, yet with a target group having a granularity greater than an individual set top terminal. Another advantage of groupcasting using unicast streams is that the number of target groups and the criteria used to define them can be dynamically adjusted. Since the SDV manager 215 controls in real time the ads that are being inserted into the programming as the program is being streamed from the streaming server 240, the SDV manager 215 can even adjust or rearrange the target groups based on its knowledge of the upcoming ads that are to be inserted from the advertising server 230. Once the SDV manager 215 redefines one or more target groups based on an upcoming ad, the set top terminals that are affected can be directed by the SDV manager to tune to the appropriate new channel for their target group. Dynamic adjustment of the target groups also allows the bandwidth to be controlled. For instance, during times when a relatively large fraction of the SDV resources are available, the SDV manager 215 can form a greater number of target groups to better target advertising. On the other hand, when SDV resources are limited, the SDV manager can consolidate target groups as necessary to conserve bandwidth.

One disadvantage of groupcasting with unicast streams is that a different stream is required for each target group. Although the streams are only delivered when a member of the target group is requesting the programming, the bandwidth usage will generally still be higher than is used in SDV groupcasting with multicast streams since there will often be many more target groups when unicast streams are used than when multicast streams are used.

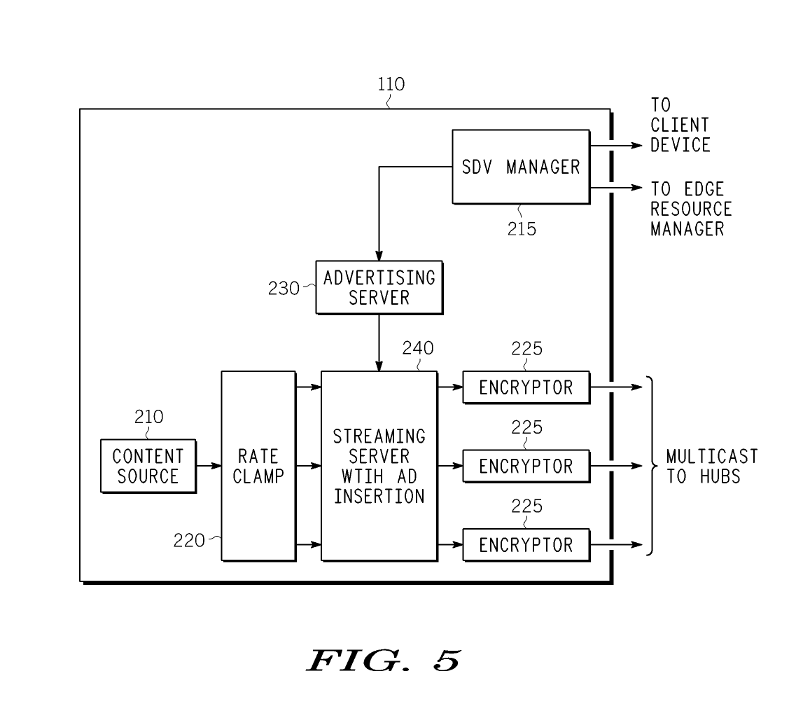

One way to alleviate the bandwidth consumption problem when groupcasting with unicast streams is to direct streaming servers to multicast the groupcast streams. FIG. 5 shows one example of a headend 110 that is configured for this purpose. The headend 110 is similar to the headend depicted in FIG. 3 in which streaming server 240 is employed, except that now the video streams are multicast to the hubs instead of being unicast. Also, since multicasting is being employed, the SDV manager 215 needs to communicate with the edge resource manager 160 in the hubs since the edge devices must be directed when to issue a IGMP Join request. The SDV manager 215 can flexibly and dynamically create target groups with this arrangement like those that are possible in groupcasting with multicast streams, while reducing the bandwidth requirements between the headend and the hubs. For instance, if two users in the same service group with the same or similar demogrpahics watch the same program, the edge device will still have to generate two unicast streams (one for each subscriber).

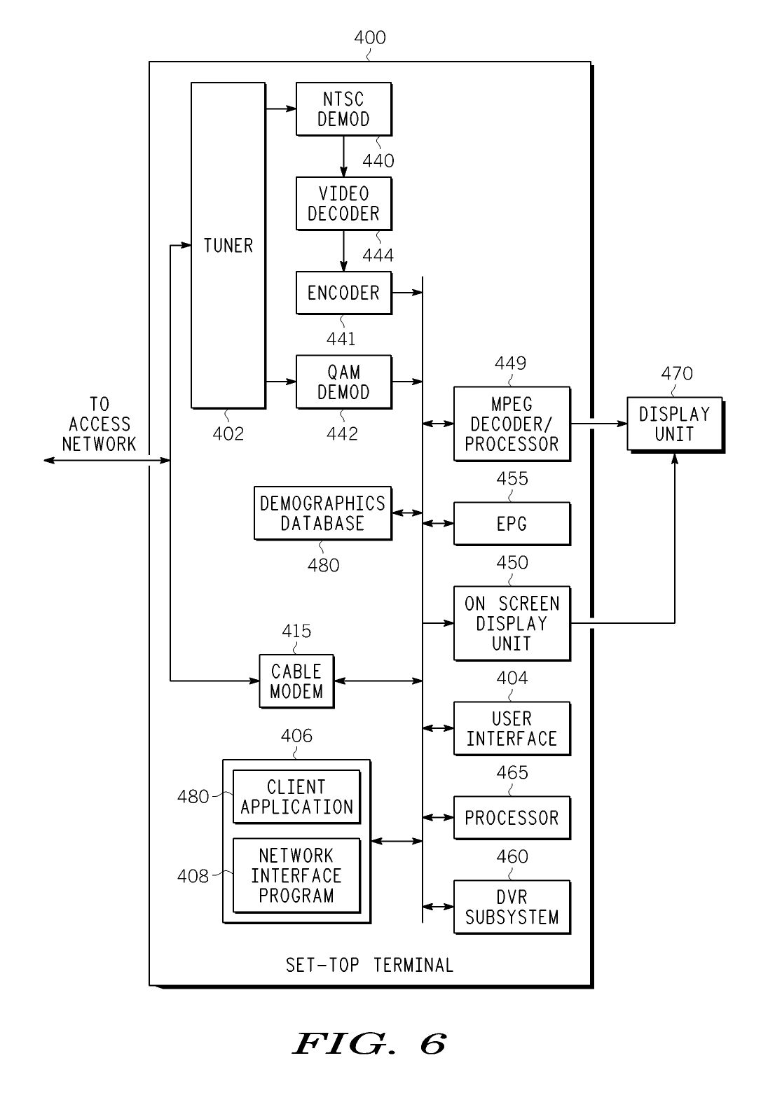

One example of a set top terminal 400 is shown in more detail in FIG. 6. It should be noted that set top terminal 400 more generally may be any apparatus such as a hardware card, specially programmed computer or other device having the functionality described herein that may be placed near to or within a television or other display device (such as a computer monitor) such as display unit 470. The set top terminal 400 receives content from cable access networks seen in FIG. 1. Broadly speaking, a traditional set top terminal such as that depicted in FIG. 6 is a device that can receive, store and forward content without manipulating the content in any significant way except to format it so that it may be rendered in a suitable manner.

Set-top terminal 400 includes an in-band tuner 402, which tunes to a channel signal selected by a consumer (not shown) via user interface 404. User interface 404 may be any control device such as a remote control, mouse, microphone, keyboard, or display. NTSC demodulator 440 and digital demodulator 442 are responsive to in-band tuner 402. NTSC demodulator 440 includes components responsive to receive analog versions of a channel signal. A digital demodulator 442, which as shown is a QAM demodulator, but, which may be any type of digital demodulator device, includes components responsive to receive digital versions of a channel signal, and to output video information. QAM demodulator 442 receives and processes digital data packets from one or more digital sources, such as a digital television signal, an MPEG transport stream, or a media stream from an external network connection, such as cable modem 415 (if available), using well-known methods and techniques. Video decoder 444 is responsive to receive and decode video information. Video information that may require format translation or modification for compatibility with capabilities of set top terminal 400 may be passed to encoder 441 for formatting. Video information that is in a format preferred for use by MPEG Decoder/Multi Media Processor 449 may be passed directly to MPEG Decoder/Multi Media Processor 449. Encoder 441 is operative to perform predetermined coding techniques (for example, MPEG-2, MPEG-4, and others) to produce an encoded video signal for transmission to MPEG Decoder/Multi Media Processor 449, or for storage. MPEG Decoder/Multi-Media Processor 449 is operative to perform predetermined coding techniques to arrange video information into displayable formats, in accordance with well-known methods and techniques. Internal arrangements of MPEG Decoder/Multi-Media Processor 449 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

An electronic program guide (EPG) 455 is also provided in set-top terminal 400. The EPG 455 is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. For example, the electronic program guide 455 may display programs in a tabular format by channel and time so that the user can make selections of desired content. In some cases, instead of transmitting it along with the programming, the electronic program guide 455 may be downloaded via a telephone line, cable connection, satellite up-link, or radio broadcast antenna.

An on-screen display unit 450 is provided in set top terminal 400. The on-screen display unit 450 is used to display information such as control menus and the like as well as information received from the service provider or MSO that needs to be directly presented to the user regardless of the particular programming or channel that the user is currently viewing. In particular, on-screen display unit 450 displays the information provided by the EPG 455. Accordingly, on-screen display unit 450 can forward the information directly to the display unit 470, where it may appear as an overlay, pop up, or scrolling text ticker that is superimposed on the current programming being viewed. Alternatively, the information from the on-screen display unit 450 may even replace the current programming that appears on the display unit 470.

DVR subsystem 460 is provided for recording programs received from the access network. DVR subsystem 460 can control the channel tuned by tuner 402 and record programming on a manual or timer control basis. Additionally, the DVR subsystem 460 can buffer incoming programs to enable a view to pause or replay a portion of a live program.

Set-top terminal may also optionally include a demographics database 480 to store the demographic information concerning the subscriber that is to be sent to the headend.

Set-top terminal 400 further includes a computer-readable storage medium 406. Computer-readable storage medium 406 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 406. The applications residing on storage medium 406 may be computer programs that include software components implemented according to well-known software engineering practices for component-based software development and stored in computer-readable memories, such as storage medium 406. The applications, however, may be any signal processing methods and/or stored instructions, in one or more parts, that electronically control functions set forth herein. Storage medium 406 may also include other programs to provide additional functionality. For example, a network interface program 408 may be provided that represents aspects of the functional arrangement of various computer programs that pertain to the receipt and processing of content and other data over a broadband system.

The various components of set top terminal 400 discussed above may all operate under the overall control of a processor 465. Moreover, it is contemplated that the processor 465, tuner 402, video decoder 449, user interface 404, onscreen display unit 450 and the other components shown in FIG. 6 may each be implemented in hardware, software or a combination thereof. In addition, although the various components are shown as separate processors, it is contemplated that they may be combined and implemented as separate processes on one or more processors.

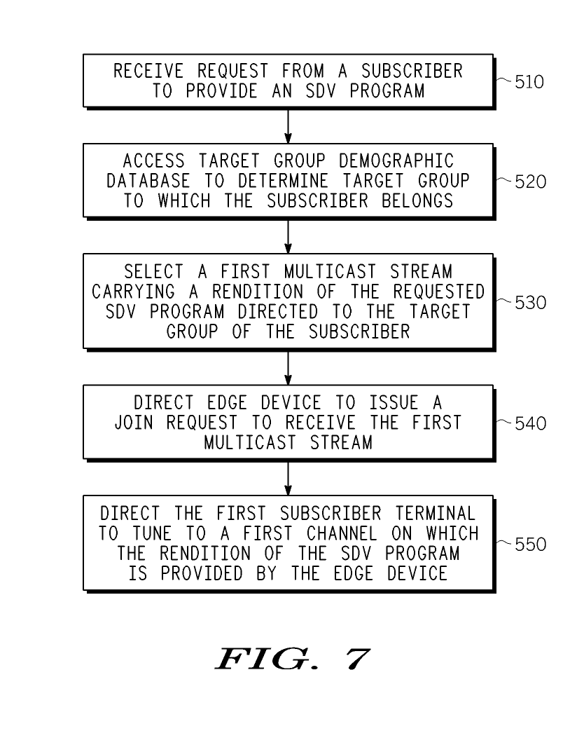

FIG. 7 is flowchart showing one example of a method for providing SDV programming with advertising that is directed to target groups of subscribers with a group size between individual set top terminals and a service group of such terminals. The method begins in step 510 when a request is received from a first subscriber terminal that wishes to receive an SDV program over an access network. In step 520, the SDV manager accesses its target group demographic database to determine which target group or groups the first subscriber terminal belongs. Next, in step 530 the SDV manager selects (if already available) or causes to be generated a first multicast stream that carries a rendition of the requested SDV program that is directed to the target group to which the first subscriber terminal belongs. The target group is a subset of subscriber terminals serviced by the edge device. The SDV manager directs an edge device in step 540 to issue a join request to receive the first multicast stream on which the SDV program is provided. Finally, in step 550 the SDV manager directs the first subscriber terminal to tune to a first channel on which the rendition of the SDV program is provided over the access network by the edge device.

The processes described above, including but not limited to those presented in connection with the headend and set-top terminal may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
receiving a request from a first subscriber terminal to receive an SDV program over an access network;
selecting a first multicast stream from among a plurality of multicast streams that each carry a different rendition of the SDV program, wherein the selection is based at least in part on a first target group of subscriber terminals to which the first subscriber terminal belongs;
directing an edge device to issue a join request to receive the first selected multicast stream on which the SDV program is provided, wherein the first target group is a subset of subscriber terminals serviced by the edge device; and
directing the first subscriber terminal to tune to a first channel on which the SDV program is provided over the access network by the edge device.

2. The computer-readable medium of claim 1 further comprising:
receiving a request from a second subscriber terminal to receive the SDV program,
determining that the second subscriber terminal belongs to the first target group of subscribers; and
directing the second subscriber terminal to tune to the first channel.

3. The computer-readable medium of claim 1 further comprising:
receiving a request from a second subscriber terminal to receive the SDV program, said second subscriber belonging to a second target group of subscribers;
selecting a second multicast stream from among the plurality of multiplexed streams, wherein the selection is based at least in part on the second target group of subscriber terminals to which the second subscriber terminal belongs;
directing the edge device to issue a join request to receive the second selected multicast stream on which the SDV program is provided;
directing the second subscriber terminal to tune to a second channel on which the SDV program is provided over the access network by the edge device.

4. The computer-readable medium of claim 1 further comprising associating subscriber terminals with the first target group if the subscriber terminals have a common demographic.

5. The computer-readable medium of claim 1 wherein the access network is an HFC network and the edge device is a QAM modulator.

6. The computer-readable medium of claim 1 wherein the multicast stream is an IP multicast stream and the join request is an IGMP join request.

7. At least one computer-readable medium encoded with instructions which, when executed by a processor, performs a method including:
receiving a request from a first subscriber terminal belonging to a first target group to receive an SDV program over an access network;
directing a streaming server to transmit a video stream that carries the requested SDV program to an edge device such that the edge device delivers a first channel on which the SDV program carried by the video stream is provided;
causing at least one advertisement to be inserted into the SDV program before a segment of the video stream where the advertisement is to be inserted is transmitted to the edge device, wherein the advertisement is selected at least in part on the first target group to which the first subscriber belongs;
directing the first subscriber terminal to tune to the first channel on which the SDV program is provided by the edge device;
receiving a request from a second subscriber terminal to receive the SDV program; and
directing the second subscriber terminal to tune to the first channel if the second subscriber terminal also belongs to the first target group.

8. The computer-readable medium of claim 1 wherein the video stream is a unicast stream.

9. The computer-readable medium of claim 8 further comprising associating the first subscriber terminal with a second target group instead of the first target group based on content of an upcoming advertisement to be inserted into a rendition of the SDV program to be provided to the second target group.

10. The computer-readable medium of claim 1 wherein the video stream is a multicast stream.

11. The computer-readable medium of claim 10 further comprising directing the edge device to issue a join request to receive the multicast stream on which the SDV program is provided.

12. The computer-readable medium of claim 7 wherein, if the second subscriber terminal belongs to a second target group, further comprising:
directing the streaming server to transmit the video stream that carries the requested SDV program to the edge device such that the edge device delivers a second channel on which the SDV program carried by the video stream is provided;
causing at least one other advertisement to be inserted into the SDV program before a segment of the video stream where the advertisement is to be inserted is transmitted to the edge device for delivery on the second channel, wherein the other advertisement is selected at least in part on the second target group to which the second subscriber belongs; and
directing the second subscriber terminal to tune to the second channel on which the SDV program is provided by the edge device.

13. The computer-readable medium of claim 7 wherein the first target group is a subset of subscriber terminals serviced by the edge device.

14. The computer-readable medium of claim 7 wherein subscriber terminals in the first target group all have at least one common demographic.

15. A switched digital video (SDV) system, comprising:
an SDV manager for coordinating a SDV session requested by a subscriber terminal;
a storage medium on which resides content to be transmitted during the SDV session;
a plurality of edge devices for receiving a transport stream that includes content provided by the storage medium and transmitting the transport stream over an access network to the subscriber terminal on one of a plurality of SDV channels; and
wherein the SDV manager is configured to cause different renditions of an SDV program to be provided by the edge devices to subscriber terminals associated with different target groups, wherein the target groups each include a plurality of subscriber terminals that is less than a number of subscriber terminals serviced by a distinct edge device or devices.

16. The switched digital video system of claim 15 wherein the SDV manager is further configured to cause the different renditions of the SDV program to be multicast to the edge devices.

17. The switched digital video system of claim 15 wherein the SDV manager is further configured to cause the different renditions of the SDV program to be unicast to the edge devices.

18. The switched digital video system of claim 15 wherein the SDV manager is further configured to associate a first subscriber terminal with a second target group instead of a first target group based on content of an upcoming advertisement to be inserted into a rendition of the SDV program to be provided to the second target group.

19. The switched digital video system of claim 16 wherein the storage medium includes a streaming server for providing the transport streams to the edge devices.

20. The switched digital video system of claim 17 wherein the storage medium includes a streaming server for providing the transport streams to the edge devices.
